(19) United States
(12) Patent Application Publication
(10) Pub. No.: US 2004/0069352 A1
(43) Pub. Date: Apr. 15, 2004

(54) Check valve

(76) Inventors: Thomas Wieland, Stuttgart (DE); Ulrich Mueller, Gerlingen (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/453,486

(22) Filed: Jun. 4, 2003

(30) Foreign Application Priority Data
Jun. 4, 2002 (DE) 1 02 24 695.5

(51) Int. Cl. F16K 15/04

(52) U.S. Cl. 137/539

(57) ABSTRACT

In the check valve according to the invention, a narrowing of the inner chamber encompassing the closing body results in the fact that the closing body already reaches—and is damped in—its end position at a comparatively low delivery quantity, which significantly reduces vibrations and thus the generation of noise. The cross section of the inner chamber narrows, for example monotonically, in the opening direction of the closing body.

### BACKGROUND OF THE INVENTION

1. Field of the Invention

The invention is directed to a check valve having improved vibration and noise characteristics.

2. Description of the Prior Art

A check valve is already known from DE 195 07 321 C2, in which the flow cross section continuously increases in size radially in the opening direction. This has the disadvantage that the closing body only assumes the open end position at comparatively higher delivery quantities and there is therefore the danger of vibrations and noise. There is also the disadvantage of higher pressure losses in certain operating states.

A check valve is also known from DE 40 29 909 C2, in which the inner chamber of the housing that contains the closing body is embodied as a cylindrical bore. A check valve of this kind has a minimal pressure loss at the lowest delivery quantity and this pressure loss increases monotonically as the delivery quantity increases.

### OBJECT AND SUMMARY OF THE INVENTION

The check valve according to the invention has the advantage over the prior art that the generation of noise is sharply reduced. A narrowing of the inner chamber causes the closing body to already reach its end position at a comparatively low delivery quantity in relation to the prior art, which further reduces oscillations and therefore the generation of noise.

A further advantage is that depending on the flow, the pressure loss that occurs passes through a minimum that can be changed through the design of the valve geometry, which minimum is not at the minimal flow and can be set, within certain limits, at a desired working point of the check valve. Using the minimal pressure loss can increase the efficiency of the delivery system.

Advantageous modifications and improvements of the check valve are possible. For example, it is particularly advantageous if the narrowing of the inner chamber cross section occurs monotonically since this has a positive effect on the pressure loss.

It is advantageous to design the closing section in the form of a sphere, a sphere segment, or a truncated cone since all of these embodiments are automatically centered as they are inserted into the valve seat and therefore produce a reliable seal. Embodying the closing body as a sphere is also advantageous because spheres can be inexpensively produced as mass produced products with a high degree of precision and in large production runs.

For a favorable sealing action against the valve seat, it is also advantageous to make the closing section out of rubber or plastic.

### BRIEF DESCRIPTION OF THE DRAWINGS

The invention will be better understood and further objects and advantages thereof will become more apparent from the ensuing detailed description of preferred embodiments taken in conjunction with the drawings, in which:

FIG. 1 shows a sectional view of a first exemplary embodiment of a check valve embodied according to the invention,

FIG. 2 shows a view of a second exemplary embodiment,

FIG. 3 shows a sectional view along the line III-III in FIG. 2,

FIG. 4 is a valve characteristic curve, which depicts the stroke h of the closing body as a function of the volumetric flow V, and

FIG. 5 is a second valve characteristic curve, which depicts the total pressure loss ΔP of the check valve as a function of the volumetric flow \dot{V}.

### DESCRIPTION OF THE PREFERRED EMBODIMENTS

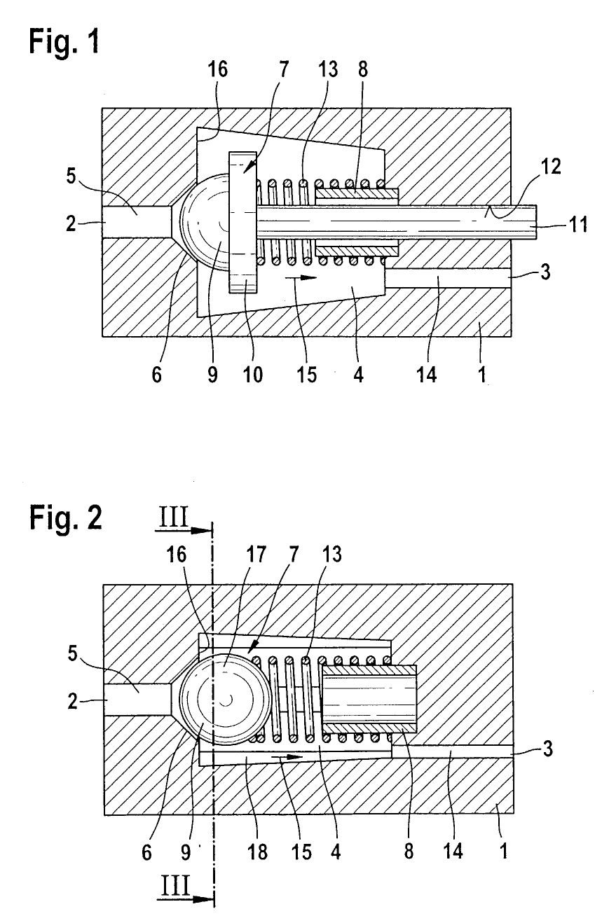

FIG. 1 shows a check valve according to the invention. A fluid can flow through this valve in only one flow direction. As a result, it can be used, for example, in a fuel supply unit of an internal combustion engine, which usually contains a fuel pump. The fuel pump delivers fuel under pressure to an internal combustion engine. For this particular application, the check valve is disposed between the fuel pump and the internal combustion engine and when the fuel pump is switched off, prevents fuel from flowing back to the fuel pump from the internal combustion engine. This maintains the fuel pressure in the internal combustion engine.

The check valve includes a housing 1 having an inlet opening 2 and an outlet opening 3, which communicate with an inner chamber 4. The inlet opening 2 leads to an inlet conduit 5, which at its other end, transitions into a for example conical valve seat 6. The valve seat 6 is disposed in a first end wall 16 of the inner chamber 4, which contains a movable closing body 7 and is connected to an outlet conduit 14 that leads to the outlet opening 3. The cross section of the inner chamber 4 narrows monotonically starting from the first end wall 16 in the opening direction 15 of the closing body 7. When the check valve is closed, the closing body 7 rests against the for example conical valve seat 6. A stop 8 limits the movement of the closing body in the opening direction 15. The closing body 7 is comprised of a closing section 9, which is oriented toward the valve seat 6 and embodied for example in the form of a hemisphere, and an adjoining cylindrical section 10. The closing section 9 here is comprised of rubber or plastic, for example. The diameter of the cylindrical section 10 can be greater than, equal to or smaller than the diameter of the closing section.

The cylindrical section 10 is provided with a guide pin 11, which is guided in a guide bore 12 of the housing 1. A compression spring 13 rests against the cylindrical section 10 of the closing body 7 and presses the closing body 7 toward the valve seat 6.

If the fuel pressure upstream of the valve seat 6 exceeds a predetermined value, then the closing body 7 lifts away from the valve seat 6. The check valve opens and fuel flows through the inlet conduit 5, the inner chamber 4, and the outlet conduit 14.

If the fuel pressure falls below this predetermined value, e.g. when the fuel pump is switched off, then the check valve closes again and the delivery of fuel stops.

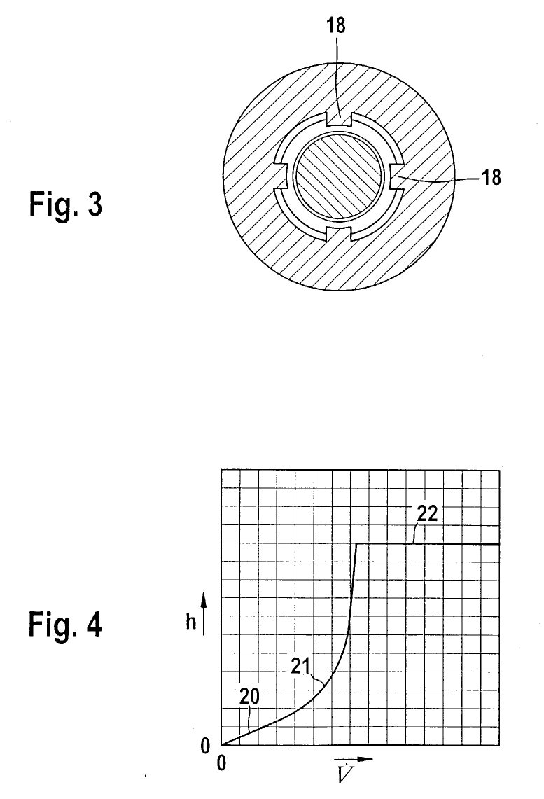

In the check valve according to FIG. 2, parts that remain the same or function in the same manner in comparison to the check valve in FIG. 1 are labeled with the same reference numerals. The check valve according to FIG. 2 differs from the check valve in FIG. 1 in that the closing body 7 is embodied as a sphere 17, which the compression spring 13 presses into the valve seat 6. The sphere 17 is guided by at least three ribs 18 distributed over the circumference of the inner chamber 4 guide, which ribs 18 can also be seen in FIG. 3, and which extend in the opening direction of the closing body.

FIG. 4 shows a characteristic curve of the check valve, depicted with the stroke h on the ordinate and the volumetric flow V on the abscissa. The characteristic curve extends in almost a straight line in a beginning region 20 and then transitions into an exponential region 21 in which a slight change in the volumetric flow v produces a large stroke h of the closing body 7. The characteristic curve then transitions into a horizontal region 22 when the cylindrical section 10 rests against the stop 8.

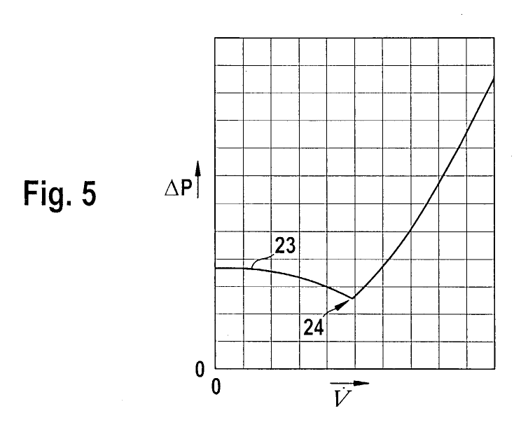

FIG. 5 shows a characteristic curve of the check valve according to the invention, depicted with the total pressure loss AP on the ordinate and the volumetric flow V on the abscissa. The total pressure loss of the check valve is chiefly composed of the pressure loss at the cross sectional reduction at the valve seat 6 and the pressure loss at the narrowing between the circumference of the inner chamber 4 and the closing body 7, 17 or the cylindrical section 10.

The narrowing of the inner chamber cross section results in the fact that the closing body 7, 17 already opens wide at a comparatively low flowing fluid quantity and the pressure loss at the valve seat 6 drops sharply as a result. By contrast, the increase in the pressure loss at the closing body 7, 17 is lower so that the total pressure loss characteristic curve 23 indicates a strongly pronounced pressure loss minimum 24.

The foregoing relates to preferred exemplary embodiments of the invention, it being understood that other variants and embodiments thereof are possible within the spirit and scope of the invention, the latter being defined by the appended claims.

We claim:

1. In a check valve comprising of a housing having an inlet opening, an outlet opening, and an inner chamber that has a valve seat at its inlet end,
a movable closing body contained in the inner chamber,
a stop limiting the movement of the closing body, and
a valve spring that acts on the closing body in the closing direction of the check valve, the improvement wherein the cross section of the inner chamber (4) encompassing the closing body (7, 17) narrows in the opening direction (15) of the check valve.

2. The check valve according to claim 1, wherein the cross section of the inner chamber (4) narrows monotonically.

3. The check valve according to claim 1, wherein that the cross section of the inner chamber (4) narrows in a graduated fashion.

4. The check valve according to claim 1, wherein the closing body (7) comprises a closing section (9) oriented toward the valve seat (6) and an adjoining downstream cylindrical section (10).

5. The check valve according to claim 1, wherein the closing body is embodied as a sphere (17).

6. The check valve according to claim 4, wherein the closing section (9) is embodied as a segment of a sphere.

7. The check valve according to claim 4, wherein the closing section (9) is embodied as a truncated cone.

8. The check valve according to claim 6, wherein the closing section (9) is comprised of rubber or plastic.

9. The check valve according to claim 7, wherein the closing section (9) is comprised of rubber or plastic.

10. The check valve according to claim 6, wherein the valve seat (6) is embodied as conical.

11. The check valve according to claim 7, wherein the valve seat (6) is embodied as conical.
